(19) United States
(12) Patent Application Publication
(10) Pub. No.: US 2024/0393807 A1
(43) Pub. Date: Nov. 28, 2024

(54) INFORMATION PROCESSING APPARATUS, INFORMATION PROCESSING METHOD, AND PROGRAM

(71) Applicant: NEC Corporation, Tokyo (JP)

(72) Inventors: Masahiro KAWATO, Tokyo (JP); Hideaki Tani, Tokyo (JP); Hiroaki Motouchi, Tokyo (JP)

(73) Assignee: NEC Corporation, Tokyo (JP)

(21) Appl. No.: 18/659,096

(22) Filed: May 9, 2024

(30) Foreign Application Priority Data
May 26, 2023 (JP) 2023-086774

(51) Int. Cl. G05D 1/69; G05D 1/224; G05D 105/20; G05D 109/10

(52) U.S. Cl. CPC G05D 1/69; G05D 1/224; G05D 2105/20; G05D 2109/10

(57) ABSTRACT

An information processing apparatus includes: a request acquisition unit configured to acquire request information being transmitted from a user terminal and including a use start point of a vehicle, a use end point of the vehicle, and a time point when the vehicle is to be used; a connected-travel plan generation unit configured to generate a travel plan for each of a plurality of vehicles including vehicles assigned to each piece of the request information in such a way that, when a degree of similarity between a plurality of pieces of the request information satisfies a predetermined criterion, the plurality of vehicles travel in a connected state in a partial travel section; and an output unit configured to output the travel plan.

### INCORPORATION BY REFERENCE

This application is based upon and claims the benefit of priority from Japanese patent application No. 2023-086774, filed on May 26, 2023, the disclosure of which is incorporated herein in its entirety by reference.

### TECHNICAL FIELD

The present disclosure relates to an information processing apparatus, an information processing method, and a program.

### BACKGROUND ART

In areas with low population density, and the like, expansion of “transportation blank areas” where access to public transportation such as railways and route buses is difficult has become a social problem. In such areas, introduction of ride-share type on-demand transportation is in progress in order to meet both transportation demand and profitability (transportation efficiency, i.e., the number of passengers per a single vehicle operation) for transport service providers (bus operators, municipalities, etc.). The ride-share type on-demand transportation (hereinafter, simply referred to as on-demand transportation) is a transportation system that receives a request including boarding/getting-off points and a desired time point from a user, and dynamically generates a travel plan in such a way that a plurality of users who have conditions indicated in the request similar to one another are transported by using a single vehicle. The ride-share type on-demand transportation is also referred to as demand-responsive transportation or an on-demand bus.

An on-demand transport system disclosed in Japanese Unexamined Patent Application Publication No. H10-241091 receives a transport request (including information about a boarding place, a getting-off place, a boarding time, and a getting-off time) from each user, and then generates a travel route by applying a predetermined criterion. In addition, when the on-demand transport system receives a request after generating the travel route, the system updates the travel route by applying the same criterion.

### SUMMARY

In on-demand transportation as described above, in order to deal with requests from a plurality of users in one operation by one vehicle, a route longer than the shortest route for each user is set as a travel route of the vehicle. In particular, in an area with low population density, a situation typically occurs in which it takes a significantly long time (for example, one hour more than travel at the shortest distance) to arrive at a destination since boarding/getting-off points over a wide geographic area are visited. This is a major dissatisfaction factor for a user, and convenience of the user is reduced. When the number of vehicles for dealing with the requests is increased in order to solve such a situation, at least a working time from a departure time to a termination time of a vehicle in charge occurs for an operator of each vehicle, and thus transportation efficiency is decreased for a transportation company.

An example object of the example embodiments disclosed in the present description is to provide an information processing apparatus, an information processing method, and a program that are capable of suppressing a decrease in transportation efficiency while also suppressing a decrease in convenience.

In a first example aspect, an information processing apparatus includes:
a request acquisition unit configured to acquire request information being transmitted from a user terminal and including a use start point of a vehicle, a use end point of the vehicle, and a time point when the vehicle is to be used;
a connected-travel plan generation unit configured to generate a travel plan for each of a plurality of vehicles including vehicles assigned to each piece of the request information in such a way that, when a degree of similarity of a plurality of pieces of the request information satisfies a predetermined criterion, the plurality of vehicles travel in a connected state in a partial travel section; and
an output unit configured to output the travel plan.

In a second example aspect, an information processing method includes, by an information processing apparatus:
acquiring request information being transmitted from a user terminal and including a use start point of a vehicle, a use end point of the vehicle, and a time point when the vehicle is to be used;
generating a travel plan for each of a plurality of vehicles including vehicles assigned to each piece of the request information in such a way that, when a degree of similarity of a plurality of pieces of the request information satisfies a predetermined criterion, the plurality of vehicles travel in a connected state in a partial travel section; and
outputting the travel plan.

In a third example aspect, a program causes a computer to execute:
a request acquiring step of acquiring request information being transmitted from a user terminal and including a use start point of a vehicle, a use end point of the vehicle, and a time point when the vehicle is to be used;
a connected-travel plan generating step of generating a travel plan for each of a plurality of vehicles including vehicles assigned to each piece of the request information in such a way that, when a degree of similarity of a plurality of pieces of the request information satisfies a predetermined criterion, the plurality of vehicles travel in a connected state in a partial travel section; and
an output step of outputting the travel plan.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a block diagram illustrating a configuration of an information processing apparatus according to the present disclosure;

FIG. 2 is a schematic diagram illustrating one example of an area in which a mobility service is provided;

FIG. 3A is a schematic diagram illustrating an association relationship between a vehicle and an operator;

FIG. 3B is a schematic diagram illustrating an association relationship between a vehicle and an operator;

FIG. 4 is a schematic diagram illustrating a configuration example of a mobility system according to the present disclosure;

FIG. 5 is a schematic diagram illustrating one example of travel plan data;

FIG. 6 is a schematic diagram illustrating one example of a travel route;

FIG. 7 is a schematic diagram illustrating one example of an operator schedule;

FIG. 8 is a schematic diagram illustrating one example of a screen for inputting a reservation request;

FIG. 9 is a schematic diagram illustrating one example of a travel plan;

FIG. 10 is a schematic diagram illustrating one example of a travel plan;

FIG. 11 is a schematic diagram illustrating one example of travel plan data;

FIG. 12 is a schematic diagram illustrating one example of an operator schedule;

FIG. 13 is a diagram illustrating one example of information to be notified to an operator;

FIG. 14 is a schematic diagram illustrating one example of a navigation screen; and

FIG. 15 is a block diagram illustrating a configuration of a computer.

### EXAMPLE EMBODIMENT

### First Example Embodiment

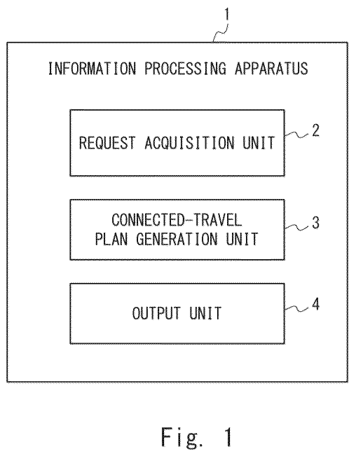

A configuration of an information processing apparatus 1 is described with reference to FIG. 1. As illustrated in FIG. 1, the information processing apparatus 1 includes a request acquisition unit 2, a connected-travel plan generation unit 3, and an output unit 4.

The request acquisition unit 2 acquires request information transmitted from a user terminal. Herein, the request information includes a use start point of a vehicle, a use end point of the vehicle, and a time point when the vehicle is to be used. The request information may further include other information. The vehicle is, for example, a vehicle being remotely operated by an operator, but may be a vehicle being driven while the operator is on the vehicle. Further, the vehicle is specifically a car, for example, but it is not necessarily a car as long as the vehicle has a function of traveling on the ground and transporting an object. The object to be transported is not limited to a person, and may be a cargo. When a degree of similarity of the acquired plurality of pieces of request information satisfies a predetermined criterion, the connected-travel plan generation unit 3 generates a travel plan for each of a plurality of vehicles including vehicles assigned to each piece of request information in such a way that the vehicles travel in a connected state in a partial travel section. The output unit 4 outputs the travel plan for each vehicle generated by the connected-travel plan generation unit 3 to a desired device. Specifically, the output of the travel plan may be display of the travel plan, transmission of the travel plan, or printing of the travel plan.

According to the information processing apparatus 1 of the first example embodiment, when the degree of similarity of the request information satisfies a predetermined criterion, a travel plan is generated and output in such a way that a plurality of vehicles travel in a connected state in a partial travel section. Therefore, according to the travel plan, in a section where a plurality of vehicles travel in a connected state, only one operator needs to perform an operation task. Therefore, efficient transportation may be achieved. Further, according to the travel plan, since a plurality of requests are not dealt with a single vehicle, it is possible to suppress a decrease in convenience of a user. That is, since each vehicle does not travel on a travel route making a long detour in order to deal with all requests, it is possible to suppress a large increase in transportation time. Therefore, according to the information processing apparatus 1, it is possible to suppress a decrease in transportation efficiency and also to suppress a decrease in convenience.

In the above description, the information processing apparatus 1 having the configuration illustrated in FIG. 1 has been described, but the mode for achieving the above-described effects is not limited to an apparatus. For example, the same effect may be achieved by an information processing method including the above-described processing of the information processing apparatus 1, a program for executing the above-described processing of the information processing apparatus 1, or a non-transitory computer readable medium in which such a program is stored.

### Second Example Embodiment

First, an outline of the second example embodiment is described. In a mobility service achieved by the second example embodiment, a remotely operated vehicle which may be remotely operated by using wireless communication and which is able to physically or logically connect a plurality of vehicles is being used. The remotely operated vehicle may be owned or rented by a user, or may be owned by a transportation service provider (transportation company). The mobility service achieved by the second example embodiment operates substantially as follows.

1. A reservation server 15 receives a reservation request including information about a boarding point, a getting-off point, and a usage time of a mobility service from a passenger, and generates a travel plan (that is, a travel route including assignment of a vehicle and time information) in such a way as to respond to the request.

2. Operators are assigned to the travel plan. The operator remotely operates the assigned vehicle via wireless communication. When a plurality of vehicles are connected, a single operator operates the plurality of connected vehicles virtually as a single vehicle.

3. When there is commonality (or similarity) in the travel route and time between the plurality of reservation requests, the reservation server 15 outputs a travel plan including travel in a state where a plurality of vehicles are connected.

According to such a mobility service, in a section where routes are common, operation is performed in a state where a plurality of vehicles are connected to each other, and in other sections, operation is performed in a state where the plurality of vehicles are separated from one another. For this reason, in a section where the plurality of vehicles travel in a connected state, only one operator needs to perform an operation task. Therefore, it is possible to suppress a decrease in transportation efficiency per operator. Further, in the present mobility service, since a plurality of requests are not dealt with a single vehicle, it is possible to suppress a decrease in convenience of a user. That is, since a single vehicle does not travel on a travel route making a long detour in order to deal with each request, a significant increase in transportation time can be suppressed.

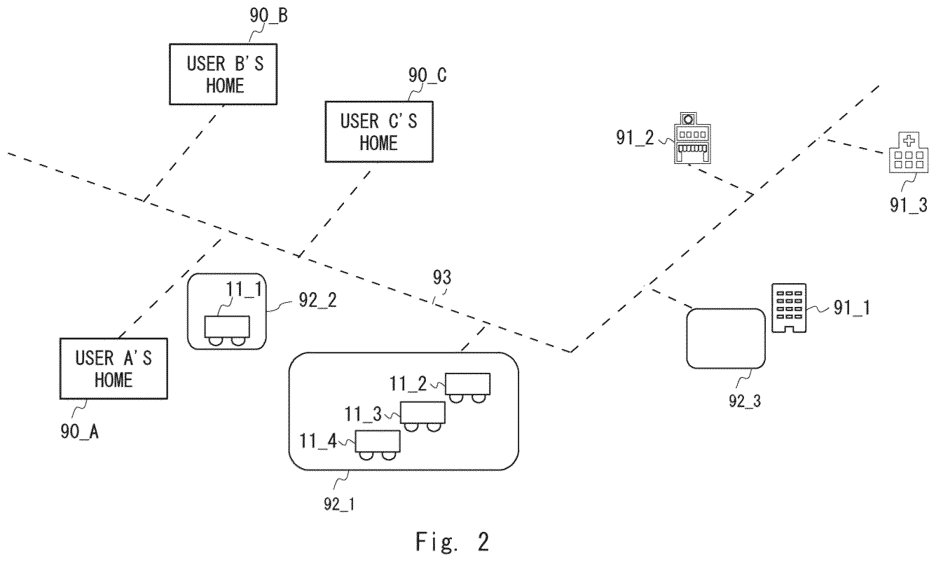

An example of an area where a mobility service is being provided is described with reference to FIG. 2. Note that, the positional relationship of elements illustrated in FIG. 2 is merely an example, and is not limited to the positional relationship illustrated in FIG. 2. Each of the vehicles 11_1, 11_2, 11_3, and 11_4 is a remotely operated vehicle and is operated according to control performed by a remote operator (not illustrated) in another place. In the following description, in a case where the vehicles 11_1, 11_2, 11_3, and 11_4 are referred to without any particular distinction, the vehicles are simply referred to as a vehicle 11. Although four vehicles 11 are illustrated in FIG. 2, the number of vehicles 11 need only be two or more in providing the present mobility service, and the number of vehicles is not limited to four. In the area illustrated in FIG. 2, a home 90_A of a user A, a home 90_B of a user B, and a home 90_C of a user C are located. In a case where the home 90_A, the home 90_B, and the home 90_C are referred to without any particular distinction, the homes are simply referred to as a home 90. Further, in the area illustrated in FIG. 2, a facility 91_1, a facility 91_2, and a facility 91_3 are located as facilities that may serve as destinations of users. In a case where the facility 91_1, the facility 91_2, and the facility 91_3 are referred to without any particular distinction, the facilities are simply referred to as a facility 91. The facility 91 is, for example, but not limited to, a government office, a supermarket, a clinic, or the like. In the area illustrated in FIG. 2, the home 90 and the facility 91 are specific examples of spots that are candidates for a use start point (i.e., a boarding point) of the vehicle 11 by the user or a use end point (i.e., a getting-off point) of the vehicle 11 by the user. A road 93 through which the vehicle 11 is able to travel connects between each of the spots. Further, in the area illustrated in FIG. 2, a parking lot 92_1, a parking lot 92_2, and a parking lot 92_3, where the vehicle 11 may be parked, are provided in places connected to the road 93. In a case where the parking lot 92_1, the parking lot 92_2, and the parking lot 92_3 are referred to without any particular distinction, the parking lots are simply referred to as a parking lot 92. Note that, the number of spots such as the home 90 and the facility 91 and the number of the parking lots 92 described above are merely examples, and are not limited to the numbers illustrated in FIG. 2.

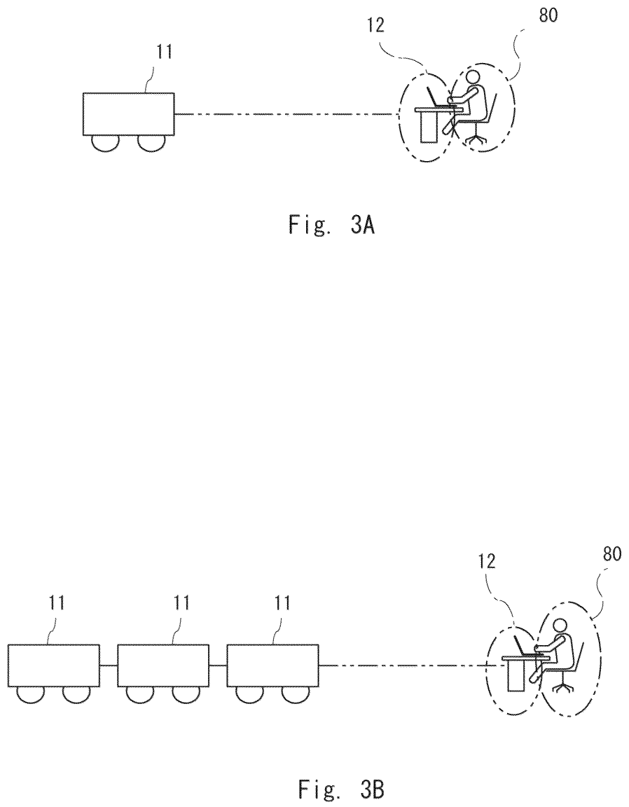

An association relationship between the vehicle 11 and an operator 80 is described with reference to FIGS. 3A and 3B. FIG. 3A is a schematic diagram illustrating an association relationship between the vehicle 11 and the operator 80 in a state where the vehicle 11 is not connected to another vehicle 11, that is, in a separated state. The operator 80 operates a remote control apparatus 12, and the vehicle 11 travels in accordance with a command transmitted from the remote control apparatus 12. In the state illustrated in FIG. 3A, one operator is able to operate only one vehicle 11. FIG. 3B is a schematic diagram illustrating an association relationship between the vehicle 11 and the operator 80 in a state where a plurality of vehicles 11 (herein, three vehicles 11 as an example) are connected. Such vehicles 11 travel virtually as a single vehicle in accordance with a command transmitted from a single remote control apparatus 12. In such a state, a single operator is able to simultaneously operate the connected plurality of vehicles 11 by operating the single remote control apparatus 12.

For example, when the vehicles 11 are connected to each other by using a physical coupler, the control target of the remote control apparatus 12 is the leading vehicle 11, and second and subsequent vehicles 11 following the leading vehicle 11 are towed by the preceding vehicle 11. Alternatively, the connection may be performed by loading another vehicle 11 onto one vehicle 11, and in such a case, the control target of the remote control apparatus 12 is the one vehicle 11 loading the another vehicle 11. Further, the connection of the vehicles 11 in the present example embodiment is not limited to a physical connection, and may be a logical connection such as platooning using vehicle-to-vehicle (V2V) communication or traveling by automatically following a preceding vehicle by using camera-image recognition. In such cases, the control target of the remote control apparatus 12 is, for example, the leading vehicle 11. In such ways, the connected vehicles 11 are integrally movable in accordance with a single command from a single remote control apparatus 12.

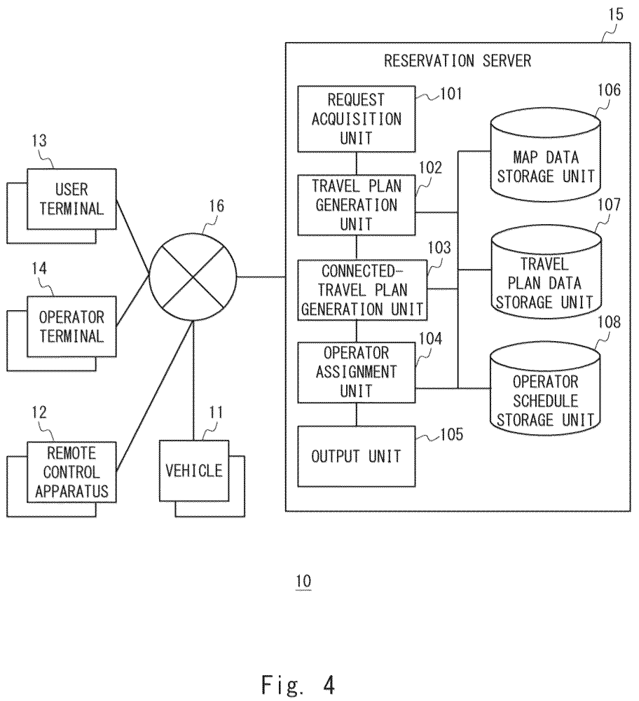

A configuration example of a mobility system 10 for implementing a mobility service is described with reference to FIG. 4. The mobility system 10 includes the vehicle 11, the remote control apparatus 12, a user terminal 13, an operator terminal 14, and the reservation server 15. Such components of the mobility system 10 are interconnected via a network 16, which may be a wireless or wired network. The network 16 is, for example, a fifth generation mobile communication network (5G), Wi-Fi (registered trademark), Ethernet (registered trademark), the Internet, or the like, but is not limited thereto.

The vehicle 11 is a remotely operated vehicle having a function of traveling in accordance with a command transmitted from the remote control apparatus 12. The vehicle 11 may have a built-in or connected sensor (a camera, a microphone, a speedometer, an accelerometer, or the like), and may have a function of transmitting a measurement result by the sensor to the remote control apparatus 12 as monitoring information. In particular, the vehicle 11 has a function of traveling virtually as one vehicle in a state where a plurality of vehicles are connected. The vehicle 11 is, for example, an electric vehicle (EV), a gasoline-engine vehicle, or the like. The mobility system 10 includes any number of vehicles 11.

The remote control apparatus 12 is an apparatus being operated by an operator to remotely control the vehicle 11. The remote control apparatus 12 includes an input device (for example, an input device simulating a control device of the vehicle 11 such as a handle, an accelerator, a brake, or the like) and an output device (for example, a display device simulating a window of the vehicle 11). The remote control apparatus 12 has a function of converting an operation made by the operator into a command (i.e., a control signal) to the vehicle 11 and transmitting the command, and a function of receiving the monitoring information transmitted from the vehicle 11 and outputting the monitoring information to the output device. The remote control apparatus 12 may be installed at any location, such as a control center where a plurality of remote control apparatuses 12 and a plurality of operators are consolidated, or a home of an operator. The mobility system 10 includes any number of remote control apparatuses 12.

The user terminal 13 is a terminal (for example, a smartphone, a tablet, a personal computer, or the like) operated by a user (passenger) of a mobility service being provided by the mobility system 10. The user terminal 13 has a function of transmitting a reservation request to the reservation server 15, based on an operation made by the user, and a function of receiving a reservation result output from the reservation server 15 and displaying the contents thereof. The mobility system 10 includes any number of user terminals 13.

The operator terminal 14 is a terminal (for example, a smartphone, a tablet, a personal computer, or the like) operated by an operator, and has a function of receiving allocation information notified from the reservation server 15 and displaying the contents thereof. The operator terminal 14 may be incorporated in the same housing as the remote control apparatus 12. The mobility system 10 includes any number of operator terminals 14.

The reservation server 15 is a server apparatus (information processing apparatus) having a function of receiving a reservation request transmitted from the user terminal 13 and assigning a vehicle 11 and an operator to the reservation request to achieve transportation according to the reservation request. The reservation server 15 corresponds to the above-described information processing apparatus 1.

As illustrated in FIG. 4, the reservation server 15 includes a request acquisition unit 101, a travel plan generation unit 102, a connected-travel plan generation unit 103, an operator assignment unit 104, an output unit 105, a map data storage unit 106, a travel plan data storage unit 107, and an operator schedule storage unit 108.

The request acquisition unit 101 acquires the reservation request transmitted from the user terminal 13. The request acquisition unit 101 is a component corresponding to the request acquisition unit 2 described above. The travel plan generation unit 102 generates a travel plan of the vehicle 11 that satisfies conditions indicated by the acquired reservation request. The connected-travel plan generation unit 103 generates a travel plan in which the plurality of vehicles 11 travel in a connected state, based on the plurality of travel plans for the plurality of reservation requests. That is, the connected-travel plan generation unit 103 corrects each of the plurality of travel plans generated by the travel plan generation unit 102 to a travel plan including connected travel. The connected-travel plan generation unit 103 is a component corresponding to the connected-travel plan generation unit 3 described above. When a degree of similarity of the plurality of reservation requests satisfies a predetermined criterion, the connected-travel plan generation unit 103 generates a travel plan for each of the vehicles 11 in such a way that the plurality of vehicles 11 travel in a connected state in a partial travel section. Herein, the plurality of vehicles 11 to be connected is a collection of vehicles 11 assigned to each reservation request. In the present example embodiment, as is described later, the degree of similarity of the reservation request is calculated by calculating the degree of similarity of the travel plan generated based on the reservation request. The operator assignment unit 104 assigns an operator to the generated travel plan, and generates a schedule for the operator (hereinafter, referred to as an operator schedule). In particular, the operator assignment unit 104 assigns one operator, who collectively operates the plurality of vehicles 11, to a partial travel section where the plurality of vehicles 11 travel in a connected state. The output unit 105 outputs the generated travel plan and operator schedule to other devices. The output unit 105 is a component corresponding to the output unit 4 described above.

The map data storage unit 106 stores map data about an area where the mobility service is being provided. The map data includes information about a road, information about a spot that may be a boarding/getting-off point, and the like. The map data is being used to generate a travel plan and the like. The information of the road and each spot in FIG. 2 is an example of the map data. The travel plan data storage unit 107 stores the generated travel plan. The operator schedule storage unit 108 stores the generated operator schedule.

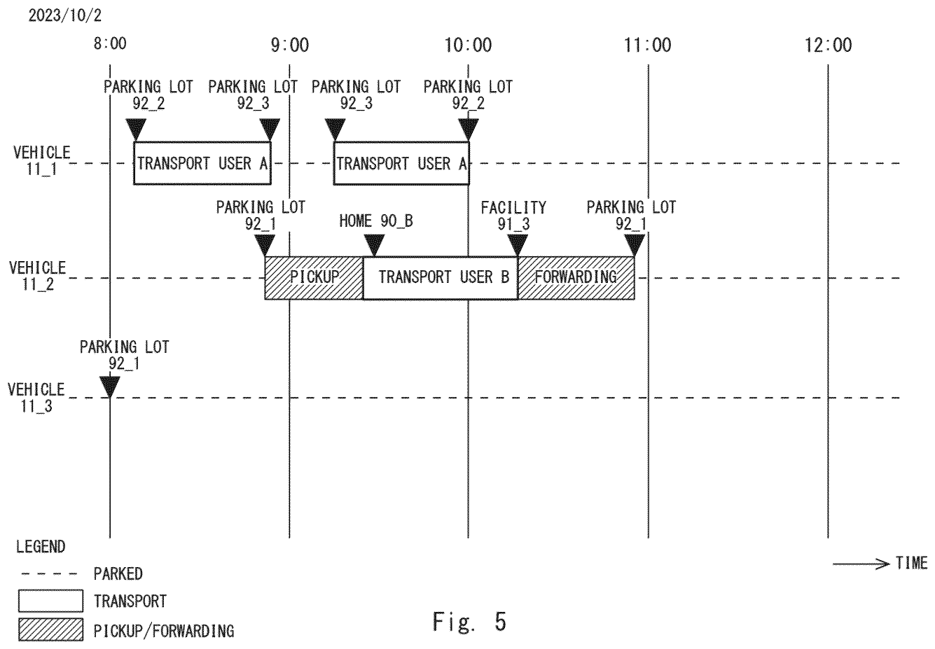

An example of the travel plan data generated by the travel plan generation unit 102 is described with reference to FIG. 5. This figure illustrates a travel plan for each vehicle 11 scheduled on Oct. 2, 2023. In this example, the travel plan of the vehicle 11_1 is as follows. According to this travel plan, the vehicle 11_1 picks up the user A at the parking lot 92_2 located in front of the user A's home 90_A and departs after 8:00, and arrives at the parking lot 92_3 in front of the facility 91_1 before 9:00. Thereafter, the vehicle 11_1 parks in the parking lot 92_3 until after 9:00, picks up the user A, and transports to the parking lot 92_2 by 10:00. Also, in this example, the travel plan of the vehicle 11_2 is as follows. According to this travel plan, the vehicle 11_2 departs from the parking lot 92_1 at 8:50, travels to the front of the user B's home 90_B for pickup, and picks up the user B. Thereafter, the vehicle 11_2 arrives at the facility 91_3 at 10:20, drops off the user B, forwards and arrives at the parking lot 92_1 on 10:55. As described above, the travel plan includes the departure point of the vehicle 11, the use start point (boarding point) of the user, the use end point (getting-off point) of the user, the terminal point of the vehicle 11, and the departure time from the departure point, the use start time of the user, the use end time of the user, and the arrival time at the terminal point. Note that the departure point of the vehicle 11 and the use start point of the user may be the same. In addition, the use end point of the user and the terminal point of the vehicle 11 may be the same.

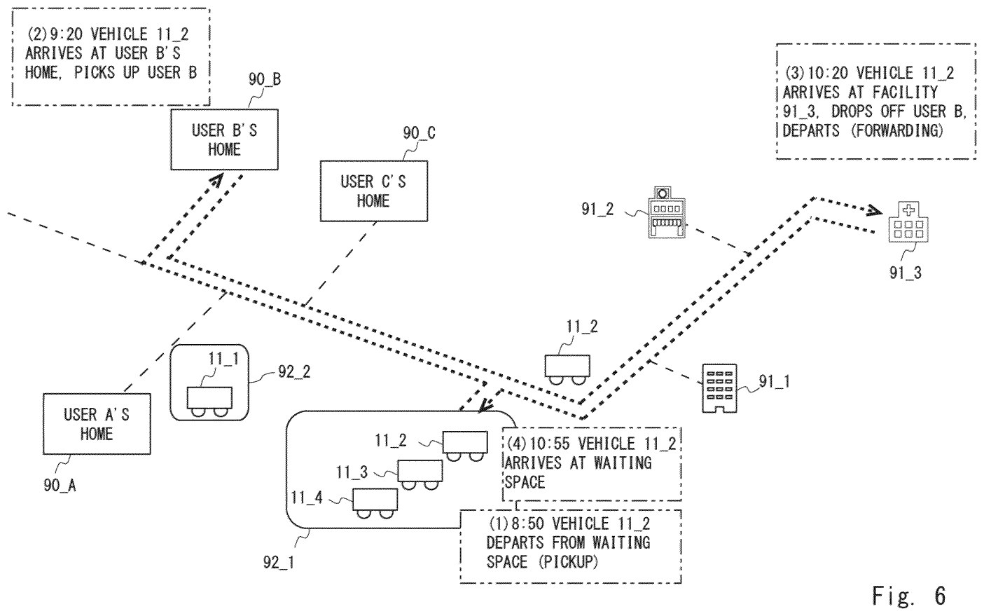

An example of a travel route recorded as part of the travel plan data is described with reference to FIG. 6. The travel route illustrated in FIG. 6 is associated with the travel plan for the vehicle 11_2 in the travel plan illustrated in FIG. 5, and represents a series of travel routes from the parking lot 92_1 to returning to the parking lot 92_1 via the front of the user B's home 90_B and the facility 91_3.

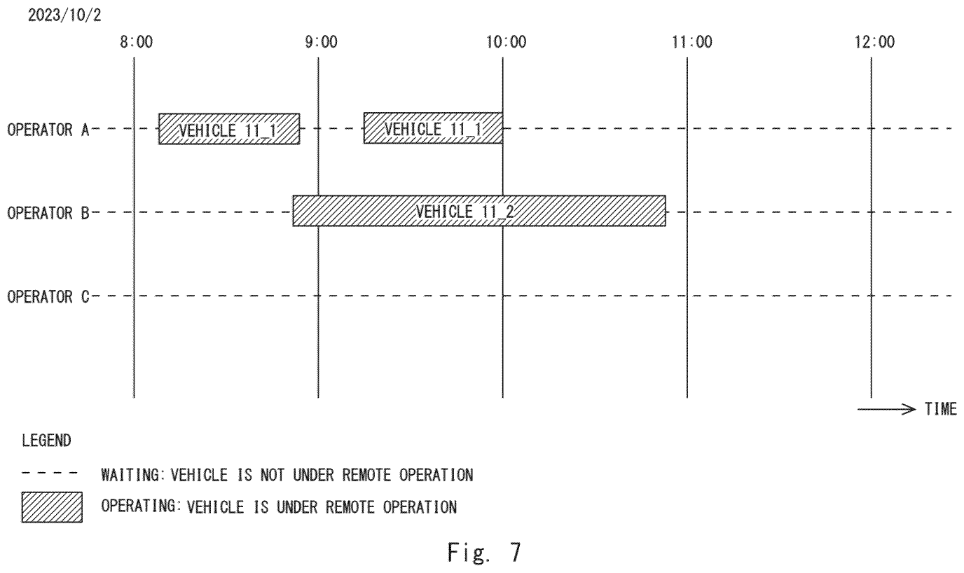

An example of an operator schedule generated by the operator assignment unit 104 is described with reference to FIG. 7. The operator schedule illustrated in this figure is associated with the travel plan data illustrated in FIGS. 5 and 6. FIG. 7 illustrates that the operator A is assigned to operating the vehicle 11_1. That is, by the operator A remotely operating the vehicle 11_1, traveling of the vehicle 11_1 from departure from the parking lot 92_2 to the arrival at the parking lot 92_3 and traveling of the vehicle 11_1 from departure from the parking lot 92_3 to the arrival at the parking lot 92_2 are achieved. FIG. 7 illustrates that the operator B is assigned to operating the vehicle 11_2. That is, by the operator B remotely operating the vehicle 11_2, travelling of the vehicle 11_2 from departure from the parking lot 92_1 to return to the parking lot 92_1 via the front of the home 90_B and the facility 91_3 is achieved.

Next, the operation of the reservation server 15 is described in detail. Note that the description is given on the assumption that each of the spots and roads are arranged as illustrated in FIG. 2. Herein, an example of processing in a case where the reservation server 15 newly receives a reservation request in a state where the travel plan and the operator schedule illustrated in FIGS. 5 to 7 have already been generated is illustrated.

### [First Step: Acquisition of Reservation Request]

The present step is performed as processing by the request acquisition unit 101. The reservation request is information requesting transportation and specifying a transportation condition. Specifically, the reservation request includes an identifier (user ID) of a user requesting transportation, a use start point (boarding point) of the vehicle 11, a use end point (getting-off point) of the vehicle 11, and time information (at least one of a use start time and a use end time) regarding a time point when the vehicle 11 is to be used. Herein, the use start time refers to a time point for departing from a use start point, that is, the boarding point, and may also be referred to as a boarding time. Further, the use end time refers to a target time point for arriving at the use end point, that is, the getting-off point, and may also be referred to as a getting-off time. The reservation request may further include other information. For example, the reservation request may include information indicating the number of passengers or may include information indicating a desired vehicle type of the vehicle 11. In addition, the reservation request may further include information indicating an allowable range of time variation of the time points specified as the time points when the vehicle 11 is to be used. Specifically, for example, the reservation request may include information indicating an allowable range for a use start time being earlier than the time point designated as the use start time, or may include information indicating an allowable range for a use end time being later than the time point designated as the use end time. The reservation request is also referred to as request information. The request acquisition unit 101 acquires a reservation request by receiving the reservation request transmitted from the user terminal 13 via the network 16.

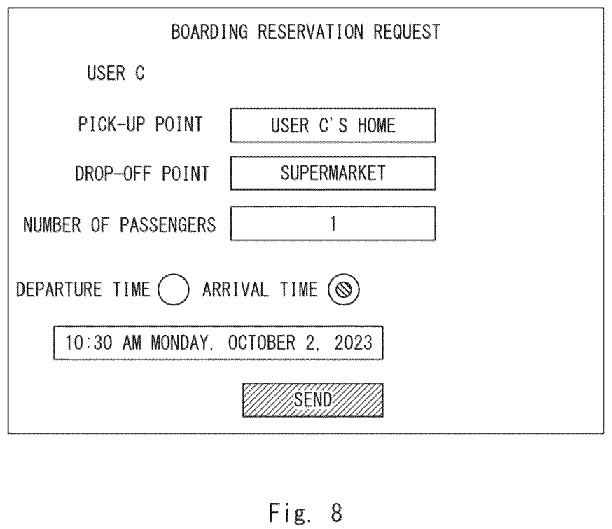

An example of a screen for inputting a reservation request, being displayed on the user terminal 13, is described with reference to FIG. 8. Typically, this screen is generated by an application program incorporated in the user terminal 13 or generated by a web browser in accordance with data (more specifically, data in HyperText Markup Language (HTML) format, or the like) transmitted from the reservation server 15. User authentication processing may be performed prior to the display of the screen for inputting the reservation request. The screen illustrated in FIG. 8 illustrates an example of a screen being displayed on the user terminal 13 of the user C. In this screen, the home of the user C (that is, the home 90_C) is specified as the boarding point, the supermarket corresponding to the facility 91_2 is specified as the getting-off point, and the arrival time to the getting-off point (use end time) is specified as 10:30 on Oct. 2, 2023.

### [Second Step: Assignment of Vehicle and Generation of Travel Plan]

The present step is performed as processing by the travel plan generation unit 102. The travel plan generation unit 102 of the reservation server 15 generates a travel plan, based on the reservation request acquired by the request acquisition unit 101. Specifically, the travel plan generation unit 102 selects a vehicle 11 to be assigned to the reservation request, and calculates a travel plan that satisfies the transportation condition specified by the reservation request. Specifically, the travel plan generation unit 102 generates a travel plan including a travel route from a departure point to a terminal point of the vehicle 11 assigned to the reservation request and time information indicating a time point when the travel is to be performed.

As for the method for selecting the vehicle 11 and the method for calculating the travel plan in the present step, any known method in on-demand transportation may be used. Herein, as an example, the travel plan generation unit 102 generates the travel plan according to the following rules. As for the travel route, a route in which an expected value of the traveling time from the use start point to the use end point is the smallest is selected. The constraint condition for selecting the vehicle 11 is, for example, the following condition. The vehicle 11 which may be selected is a vehicle 11 that is able to move to the use start point by the use start time, is not reserved from the departure time from the departure point to the termination time at the terminal point, is able to move to the use end point by the use end time, and satisfies the specified vehicle condition. The specified vehicle condition is a condition of a vehicle type, a condition of the number of passengers, and the like specified in the reservation request. In a case where only the use end time (that is, the target arrival time to arrive at the getting-off point) is specified in the reservation request and the use start time is not specified, for example, the following time point is set as the use start time. In such a case, as the use start time, for example, the latest time point among the departure times from the use start point that enables arrival at the getting-off point by the target arrival time is being used. Note that an earlier time point may be used as the use start time. In a case where only the use start time (that is, the departure time from the boarding point) is specified in the reservation request and the use end time is not specified, for example, the following time point is set as the use end time. In such a case, for example, the earliest time point at which the vehicle is able to arrive at the getting-off point when the vehicle departs from the boarding point at the designated time is being used as the use end time. Note that a later time point may be used as the use end time. In a case where there are a plurality of vehicles 11 satisfying the constraint conditions, a vehicle 11 having other reservations on the same day may be selected with priority.

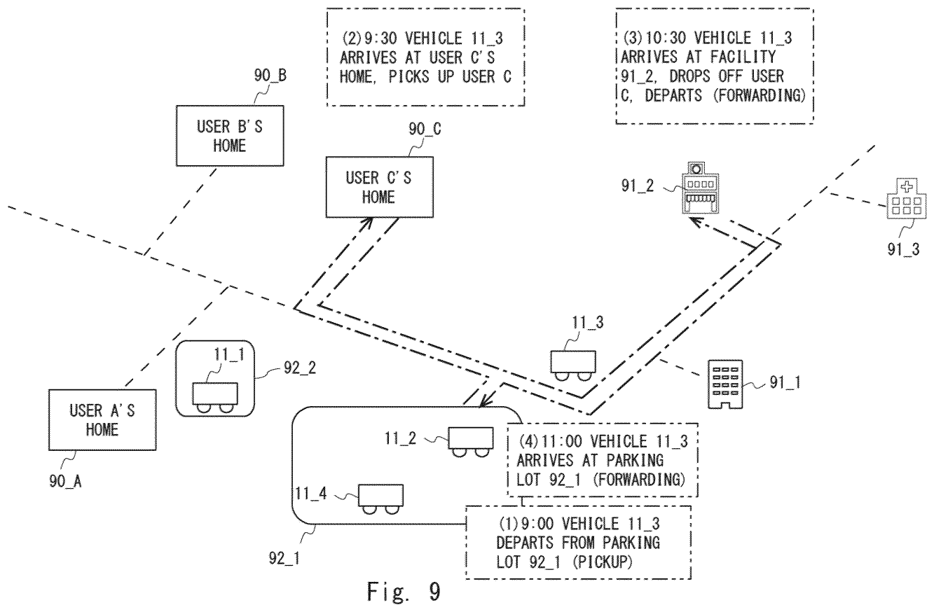

An example of a travel plan generated for a new reservation request is described with reference to FIG. 9. FIG. 9 illustrates an example of a travel plan generated by the travel plan generation unit 102 when the request acquisition unit 101 acquires the new reservation request illustrated in FIG. 8 in a state where the map data illustrated in FIG. 2 and the travel plan data illustrated in FIG. 5 are stored in the reservation server 15. In this example, the vehicles 11_1 and 11_2 have already been assigned to other reservation requests, and it is not possible to assign these vehicles to the reservation requests illustrated in FIG. 8. Therefore, the travel plan generation unit 102 assigns the vehicle 11_3 which has not yet been reserved to the new reservation request.

The travel plan illustrated in FIG. 9 includes information about a travel route illustrated in (1) to (4) described below for the vehicle 11_3. Herein, it is assumed that, when further another reservation request is not assigned to the vehicle 11_3, a rule for generating a travel plan to forward to the parking lot 92_1 after transportation of a passenger is set in advance.

(1) At 9:00, the vehicle 11_3 departs from the parking lot 92_1 where the vehicle 11_3 has been parked until then, and heads to the user C's home 90_C specified as the use start point for pickup.

(2) The vehicle 11_3 arrives in front of the home 90_C at 9:30, picks up the user C, and starts transportation toward the facility 91_2 (supermarket) being a getting-off point (use end point).

(3) The vehicle 11_3 arrives at the facility 91_2 (supermarket) at 10:30, drops off the user C, and starts forwarding to the parking lot 92_1 being the terminal point.

(4) The vehicle 11_3 arrives at the parking lot 92_1 at 11:00 and parks.

### [Third Step: Generation of Travel Plan Including Vehicle Connection]

The present step is performed as processing by the connected-travel plan generation unit 103. The connected-travel plan generation unit 103 compares the travel plan generated in the second step (hereinafter, referred to as [travel plan A] for convenience) with another travel plan already stored as travel plan data. Note that, since the travel plan A is the travel plan to be processed in the present step, the travel plan A may be referred to as a target travel plan. Then, when there is another travel plan having commonality in the travel route and the travel timing (travel date and travel time range) between the travel plan A, the connected-travel plan generation unit 103 generates a travel plan including connection of vehicles 11. Note that, in the present disclosure, the time range means a time from a first time point to a second time point, and is also referred to as a time zone. The connected-travel plan generation unit 103 updates (corrects) each travel plan having commonality to a travel plan including the connection of the vehicles 11. That is, the connected-travel plan generation unit 103 updates the travel plan the data of which is already stored in the travel plan data storage unit 107 and the travel plan associated with the new reservation request generated in the second step to the travel plan including the connection of the vehicles 11.

Hereinafter, a specific processing procedure of the connected-travel plan generation unit 103 for generating a travel plan including vehicle connection is described. First, the connected-travel plan generation unit 103 refers to date information (travel date) included in the travel plan A, and acquires all travel plans in which the travel date is the same as that of the travel plan A, among travel plans the data of which is already stored in the travel plan data storage unit 107. Each travel plan being acquired is a candidate of a travel plan to be changed to a travel plan including connection of the vehicles 11, and therefore, is hereinafter referred to as a connection candidate travel plan. Herein, each travel plan (connection candidate travel plan) being acquired is a series of travel plans for one vehicle 11 from a departure point to a terminal point. Note that, the entire area in which the mobility service is provided may be divided into a plurality of sub-areas, and in such a case, the connected-travel plan generation unit 103 may acquire only a travel plan for transport in the same sub-area as the sub-area in which the transport according to the travel plan A is performed.

Next, the connected-travel plan generation unit 103 calculates, for each of the connection candidate travel plans, a degree of similarity with the travel plan A. Thus, the degree of similarity between the reservation request (request information) associated with the travel plan A and the reservation request (request information) associated with the connection candidate travel plan is calculated. Various definitions are possible as the definition of the degree of similarity, but the degree of similarity is defined in advance in such a way that the longer the common portion is in the travel route and the closer the travel time range of the common travel route is, the higher the degree of similarity is. Therefore, the calculated degree of similarity may be referred to as a degree of similarity between the reservation requests regarding the travel route and the travel time range of the vehicle 11 for achieving the transportation requested in the reservation request. When calculating the degree of similarity between the travel plan A and the connection candidate travel plan, the connected-travel plan generation unit 103 may change a part of the travel route by allowing the travel time to extend within a predetermined range in either or both of the travel plan A and the connection candidate travel plan. That is, the connected-travel plan generation unit 103 may correct the travel route in such a way that a common section is generated in the travel route. In addition, when calculating the degree of similarity, the connected-travel plan generation unit 103 may change the travel time range within a predetermined allowable range in either or both of the travel plan A and the connection candidate travel plan. When the allowable range of time variation is specified by the user in the reservation request, the travel route or the travel time range may be changed within such an allowable range. As described above, the connected-travel plan generation unit 103 may correct the travel route or travel time range in a case of traveling without being connected to another vehicle 11 within a predetermined allowable range, and calculate the degree of similarity by using the corrected travel route or travel time range. As a result, it is possible to achieve a large number of connected travels, and it is possible to further improve the transportation efficiency. Note that, the above-described predetermined allowable range may be, for example, an allowable range of a deviation amount from the distance of the shortest path, or may be an allowable range of a deviation amount from the specified or set time.

After the calculation of the degree of similarity, the connected-travel plan generation unit 103 corrects the pair of the travel plan A and the connection candidate travel plan in which the degree of similarity is equal to or greater than a predetermined threshold value to the travel plan including the connection of the vehicles 11. That is, the connected-travel plan generation unit 103 generates a travel plan in which the vehicles 11 travel in a state of being connected in a common travel section. In a case where there are a plurality of connection candidate travel plans in which the degree of similarity with the travel plan A is equal to or greater than the threshold value, the connected-travel plan generation unit 103 may generate a travel plan including the connection of the vehicles 11 with respect to a connection candidate travel plan having the largest degree of similarity among the connection candidate travel plans. When the travel route or the travel time range is changed at the time of calculating the degree of similarity, the connected-travel plan generation unit 103 generates a travel plan that reflects the change and includes the connection of the vehicle 11. In the case of change of the travel route or the travel time range at the time of calculating the degree of similarity, the allowable range of the change may be set to be larger in a section (a pickup section or a forwarding section) where the vehicle travels without a passenger thereon than in a section where a passenger is being transported. That is, the allowable range for a travel section where the vehicle 11 travels in a state in which an object to be transported (a person in the present example embodiment) is not on the vehicle 11 may be larger than the allowable range for a travel section where the vehicle 11 travels in a state in which the object to be transported is on the vehicle 11. Thus, the influence on the user can be suppressed. As described above, the allowable amount of the deviation amount of the travel route and the allowable amount of the deviation amount of the travel time range may be different depending on whether the travel section is a boarded section. In the generation of the travel plan including the connection of the vehicles 11, constraint conditions such as a combination of connectable vehicles and the maximum number of connectable vehicles may be provided. In such a case, the connected-travel plan generation unit 103 generates a travel plan including the connection of the vehicles 11 in such a way as to satisfy the constraint condition.

Herein, a travel plan including connection of the vehicles 11_2 and 11_3 is described by taking the travel plan (corresponding to the above-described connection candidate travel plan) of the vehicle 11_2 illustrated in FIG. 6 and the travel plan (corresponding to the above-described travel plan A) of the vehicle 11_3 illustrated in FIG. 9 as examples.

The travel plan illustrated in FIG. 6 and the travel plan illustrated in FIG. 9 both have a traveling time range of from around 9:00 to around 11:00 on Oct. 2, 2023, and partially include a common section in the travel route. Therefore, the degree of similarity between the two plans is high, and both plans are subject to generation of a travel plan including connection. Herein, for example, in a case where a section in which a passenger is not transported is set with priority as a connection section, a part of a pickup section between departure from the parking lot 92_1 to arrival at the home 90_B or the home 90_C, and a part of a forwarding section between dropping off of a passenger and returning to the parking lot 92_1, are sections where the vehicle travels in a connected state.

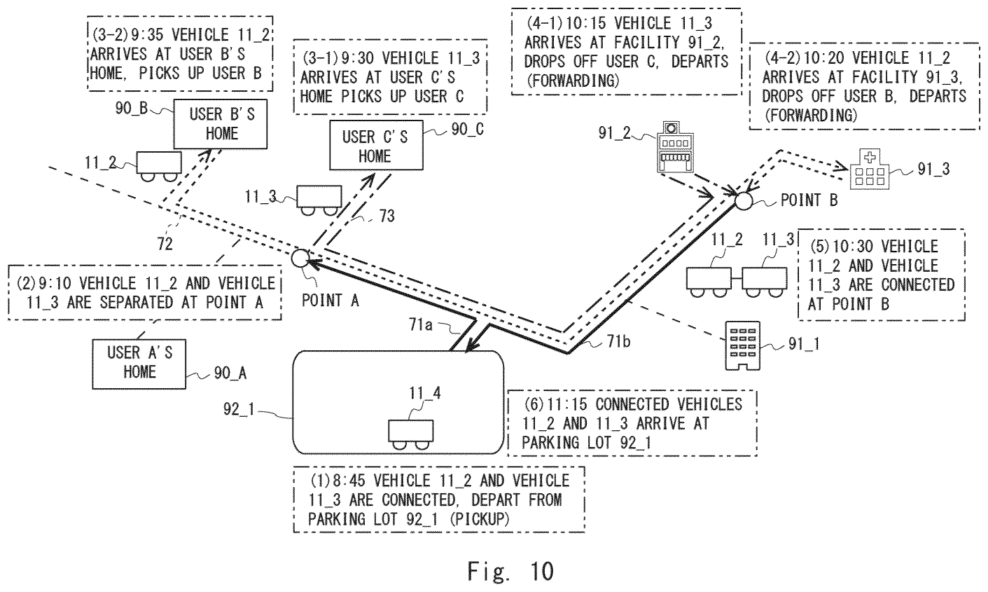

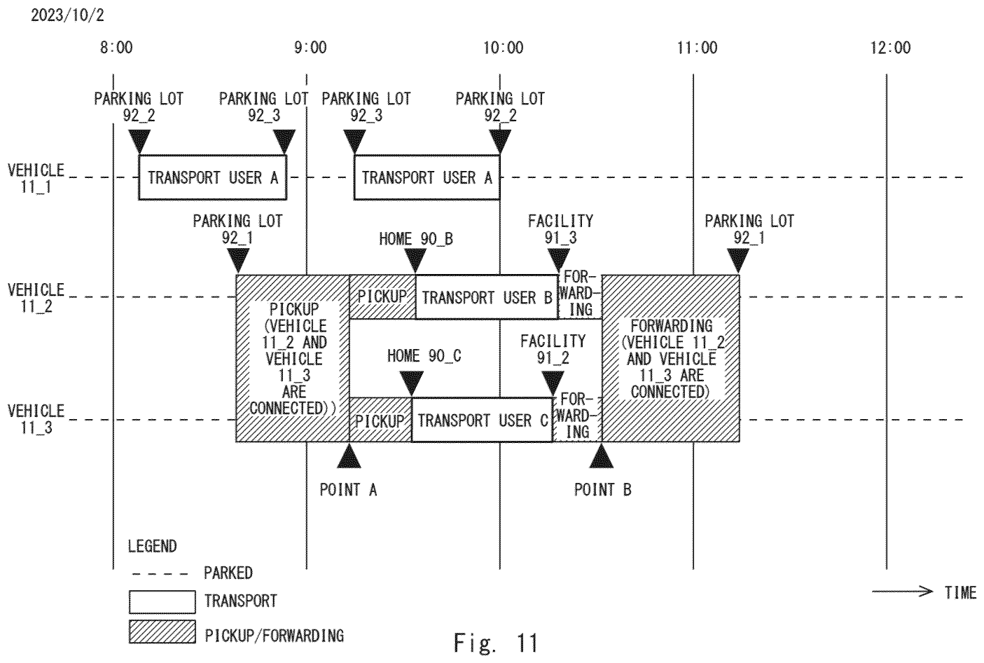

An example of a travel plan generated by the connected-travel plan generation unit 103 is described with reference to FIG. 10. Herein, a travel plan is generated in which the vehicles 11_2 and 11_3 travel in a connected state on a route 71a from the parking lot 92_1 to the point A (intermediate point of the pickup) and a route 71b from the point B (intermediate point of the forwarding) to the parking lot 92_1. In the figure, a route 72 indicates a route on which the vehicle 11_2 travels alone, and a route 73 indicates a route on which the vehicle 11_3 travels alone. In relation to this example, travel plan data represented in the same format as the travel plan data illustrated in FIG. 5 is illustrated in FIG. 11. In FIG. 5, the travel plan of the vehicle 11_2 alone is generated, whereas in FIG. 11, the travel plan is updated in such a way that the vehicles 11_2 and 11_3 travel in a connected state in a partial section of the pickup section and the forwarding section.

### [Fourth Step: Assignment of Operator]

The present step is performed as processing by the operator assignment unit 104. The operator assignment unit 104 assigns an operator for remotely operating the vehicle 11 to the travel plan generated in the second step or the third step. As a constraint condition for the assignment of the operator, the operator to be assigned needs to be an operator who has not been assigned to another travel plan in which the travel date and the travel time range overlap with that of the travel plan to be assigned. When there is no operator who satisfies such a condition, the processing of the reservation request acquired in the first step fails, and the travel plan data for the generated travel plan is not stored. When the travel plan data has already been stored before the present step, rollback to the state before storage is performed. The operator assignment unit 104 determines, from among operators satisfying the constraint condition, an operator to be assigned to the travel plan, according to a predetermined priority. Any criterion may be used as the criterion of priority. For example, the operator assignment unit 104 selects with priority an operator assigned to another travel plan on the same day, as long as an operation rate (the time assigned to operation among all work hours) is less than a predetermined value. When the operator is successfully assigned, the operator assignment unit 104 stores the operation schedule in the operator schedule storage unit 108. In addition, the connected-travel plan generation unit 103 or the travel plan generation unit 102 stores travel plan data about the generated travel plan in the travel plan data storage unit 107.

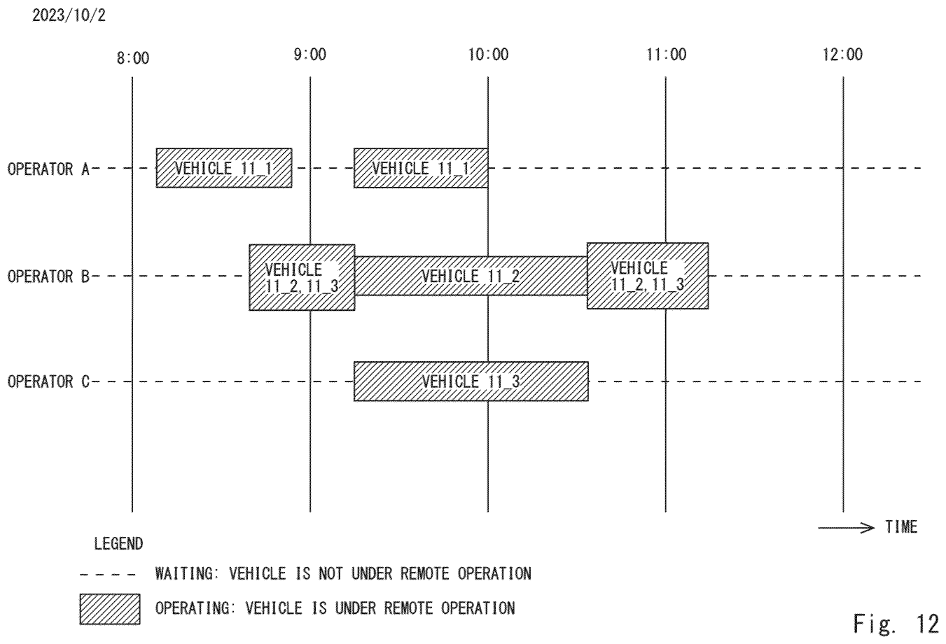

FIG. 12 illustrates an example of a result of the operator's assignment to the specific travel plan illustrated in FIG. 11. Compared to the operation schedule (FIG. 7) before generating the travel plan including vehicle connection, the operation schedule illustrated in FIG. 12 is different from the operation schedule illustrated in FIG. 7 in the following points. In the operation schedule illustrated in FIG. 12, operation of the vehicle 11_3 is assigned to an operator C. Further, in the operation schedule illustrated in FIG. 12, schedule of an operator B assigned to the vehicle 11_2 is changed to a schedule for operating the vehicles 11_2 and 11_3 in a connected state in a partial travel section.

### [Fifth Step: Output of Travel Plan]

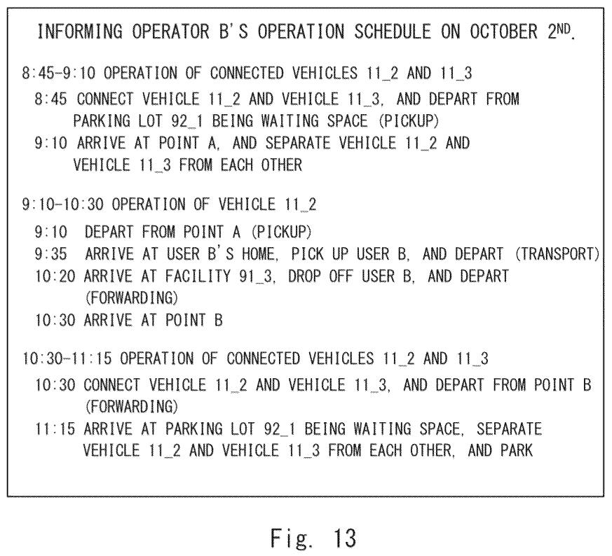

The present step is performed as processing by the output unit 105. Upon success of assignment of an operator in the fourth step, the output unit 105 notifies the user terminal 13 being the transmission source of a reservation request of the reservation success, as a response to the reservation request acquired in the first step. Further, the output unit 105 outputs the travel plan (travel plan data) to an arbitrary device. The output unit 105 may transmit the travel plan data to the operator terminal 14 of the operator to which the travel plan indicated in the data is assigned, or may transmit the travel plan data to another device that manages the travel. Further, the output unit 105 may transmit the travel plan data to the user terminal 13 being the transmission source of the reservation request. Further, the output unit 105 notifies the operator terminal 14 of an operator being associated with an operator schedule of the operator schedule at a predetermined timing. The notification timing may be set to any timing. As an example, the operator terminal 14 is notified of the operator's operation schedule assigned to the travel plan of the next day once a day. Needless to say, the output unit 105 may immediately notify the operator terminal 14 of the operator schedule upon confirmation of the travel plan. Upon receiving the operation schedule, the operator terminal 14 displays information as illustrated in FIG. 13.

Note that the reservation server 15 may provide a function enabling a user or an operator to negotiate with the reservation server 15 before the reservation is confirmed. For example, when a reservable travel time does not satisfy the condition of the time specified by the user in the reservation request, the reservation server 15 may transmit, to the user terminal 13, an inquiry notification inquiring the user whether to establish the reservation of transportation at the reservable travel time. Then, the reservation server 15 may establish such a reservation for transportation only when a response indicating that the reservation is to be established is acquired from the user terminal 13, that is, when the user accepts the reservation. That is, the reservation server 15 may generate such a travel plan for transportation as a final travel plan. When the travel date and time specified in the reservation request and the transmission date and time of the reservation request itself are close to each other, the reservation server 15 may transmit a notification as follows. In such a case, the reservation server 15 may transmit, to the operator terminal 14, an inquiry notification inquiring the operator to whom the travel plan associated with the reservation request is assigned as to whether the reservation is to be established. For example, the reservation server 15 may transmit the inquiry notification to the operator terminal 14 when the travel date specified in the reservation request and the transmission date of the reservation request itself are the same day. Then, the reservation server 15 may establish the reservation only when a response indicating that the reservation is to be established is acquired from the operator terminal 14, that is, when the operator accepts the reservation. That is, the reservation server 15 may generate an operator schedule of the final version.

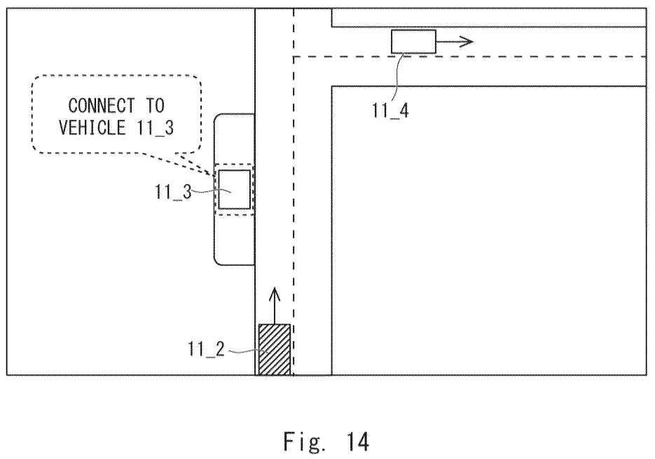

Note that, the output unit 105 may output information assisting an operator operating a vehicle 11 to an apparatus (for example, the remote control apparatus 12) being used by the operator, when the vehicle 11 is traveling. In particular, the output unit 105 may output information related to a vehicle 11 being a connection partner of the vehicle 11 being operated by the operator, based on the travel plan. As a result, the operator can easily recognize the vehicle 11 being the connection partner. For example, as illustrated in FIG. 14, the output unit 105 may output information specifying the vehicle 11 being the connection partner of the vehicle 11 being operated by the operator on the navigation screen. In FIG. 14, specifically, in a navigation screen (for example, a screen displayed on the remote control apparatus 12) for an operator operating the vehicle 11_2, a display for specifying the vehicle 11_3 to be connected and present in front of the vehicle 11_2 being operated by the operator is displayed. It is preferable that the display for specifying the connection target is a display highlighted so as to attract the operator's attention. Note that the information related to the vehicle 11 and output by the output unit 105 may be information indicating an appearance characteristic of the vehicle 11 to be connected.

The second example embodiment has been described above. According to the present example embodiment, it is possible to travel in a state where a plurality of vehicles 11 are connected in a section in which routes are common. According to the present example embodiment, only one operator is assigned to the traveling of the plurality of vehicles 11 in such a section. Therefore, in such a section, only one operator needs to perform an operation task. Therefore, efficient transportation can be achieved. In addition, since each vehicle 11 does not need to travel on a travel route making a long detour, an increase in transportation time can be prevented. Therefore, according to the present example embodiment, it is possible to suppress the decrease in transportation efficiency and the decrease in convenience.

Note that, the above-described functions (processing) of the remote control apparatus 12, the user terminal 13, the operator terminal 14, or the reservation server 15 may be implemented by a computer 500 having the following configuration, for example.

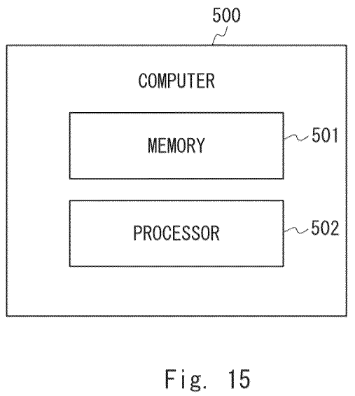

A configuration of the computer 500 that implements processing of the remote control apparatus 12, the user terminal 13, the operator terminal 14, or the reservation server 15 is described with reference to FIG. 15. As illustrated in FIG. 15, the computer 500 includes a memory 501 and a processor 502.

The memory 501 is configured of, for example, a combination of a volatile memory and a non-volatile memory. The memory 501 is used to store programs being executed by the processor 502, data being used for various processing, and the like. The map data storage unit 106, the travel plan data storage unit 107, and the operator schedule storage unit 108 may be achieved by the memory 501. However, such storage units may be achieved by any other storage devices.

The processor 502 reads a program from the memory 501 and executes the program, thereby performing processing of each device. The processor 502 may be, for example, a microprocessor, a microprocessor unit (MPU), or a central processing unit (CPU). The processor 502 may include a plurality of processors.

When the program is read by the computer, the program includes instructions (or software cods) for causing the computer to execute one or more functions described in the example embodiment. The program may be stored in a non-transitory computer-readable medium or a tangible recording medium. Although not limited thereto, examples of the computer-readable medium or the tangible recording medium include a random-access memory (RAM), a read-only memory (ROM), a flash memory, a solid-state drive (SSD), or other memory techniques, a CD-ROM, a digital versatile disc (DVD), a Blu-ray (registered trade name) disc, or other optical disc storages, a magnetic cassette, a magnetic tape, a magnetic disc storage, and other magnetic storage devices. The program may be sent on a transitory computer-readable medium or a communication medium. Although not limited thereto, examples of the transitory computer-readable medium or the communication medium include electrical, optical, acoustic, or other forms of propagating signals.

The present invention is not limited to the above-described example embodiments, and may be appropriately modified without departing from the scope and spirit. For example, an object to be transported may not be a user, and may be a cargo designated by the user, or may be both a user and a cargo. When a cargo is included in the object to be transported, the reservation server 15 may also generate a plan for a schedule of a person or a robot in charge of loading the cargo into the vehicle 11 and unloading the cargo from the vehicle 11. In addition, the above-described reservation server 15 may be used not as an on-demand transport service but as a designated driver service for offering driving of the vehicle 11 managed by a user.

According to the present disclosure, it is possible to provide an information processing apparatus, an information processing method, and a program that are capable of suppressing a decrease in transportation efficiency while also suppressing a decrease in convenience.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

The whole or part of the example embodiments disclosed above can be described as, but not limited to, the following supplementary notes. Some or all of elements (e.g., structures and functions) specified in Supplementary notes 2 to 7 dependent on Supplementary note 1 may also be dependent on Supplementary note 8 and Supplementary note 9 in dependency similar to that of Supplementary notes 2 to 7 on Supplementary note 1. Some or all of elements specified in any of Supplementary notes may be applied to various types of hardware, software, and recording means for recording software, systems, and methods.

### (Supplementary Note 1)

An information processing apparatus including:
a request acquisition unit configured to acquire request information being transmitted from a user terminal and including a use start point of a vehicle, a use end point of the vehicle, and a time point when the vehicle is to be used;
a connected-travel plan generation unit configured to generate a travel plan for each of a plurality of vehicles including vehicles assigned to each piece of the request information in such a way that, when a degree of similarity of a plurality of pieces of the request information satisfies a predetermined criterion, the plurality of vehicles travel in a connected state in a partial travel section; and
an output unit configured to output the travel plan.

### (Supplementary Note 2)

The information processing apparatus according to supplementary note 1, wherein the vehicle is a vehicle being remotely operated by an operator.

### (Supplementary Note 3)

The information processing apparatus according to supplementary note 1 or 2, further including an operator assignment unit configured to assign a single operator for collectively operating the plurality of vehicles to the partial travel section where the plurality of vehicles travel in a connected state.

### (Supplementary Note 4)

The information processing apparatus according to any one of supplementary notes 1 to 3, wherein the degree of similarity is a degree of similarity between pieces of the request information regarding a travel route of the vehicle and a travel time range of the vehicle for achieving transportation requested in the request information.

(Supplementary note 5)

The information processing apparatus according to supplementary note 4, wherein the connected-travel plan generation unit corrects the travel route or the travel time range in a case where the vehicle travels without being connected to another vehicle within a predetermined allowable range, and calculates the degree of similarity between pieces of the request information by using the corrected travel route or travel time range.

### (Supplementary Note 6)

The information processing apparatus according to supplementary note 5, wherein the predetermined allowable range for a travel section where the vehicle travels in a state where an object to be transported is not on the vehicle is larger than the predetermined allowable range for a travel section where the vehicle travels in a state where the object to be transported is on the vehicle.

### (Supplementary Note 7)

The information processing apparatus according to any one of supplementary notes 1 to 6, wherein the output unit further outputs, to an apparatus being used by an operator of the vehicle, information related to a vehicle being a connection partner of the vehicle.

### (Supplementary Note 8)

An information processing method including, by an information processing apparatus:
acquiring request information being transmitted from a user terminal and including a use start point of a vehicle, a use end point of the vehicle, and a time point when the vehicle is to be used;
generating a travel plan for each of a plurality of vehicles including vehicles assigned to each piece of the request information in such a way that, when a degree of similarity of a plurality of pieces of the request information satisfies a predetermined criterion, the plurality of vehicles travel in a connected state in a partial travel section; and
outputting the travel plan.
   (Supplementary note 9)

A non-transitory computer readable medium storing a program that causes a computer to execute:
a request acquiring step of acquiring request information being transmitted from a user terminal and including a use start point of a vehicle, a use end point of the vehicle, and a time point when the vehicle is to be used;
a connected-travel plan generating step of generating a travel plan for each of a plurality of vehicles including vehicles assigned to each piece of the request information in such a way that, when a degree of similarity of a plurality of pieces of the request information satisfies a predetermined criterion, the plurality of vehicles travel in a connected state in a partial travel section; and
an output step of outputting the travel plan.

What is claimed is:

1. An information processing apparatus comprising:
at least one memory storing instructions; and
at least one processor configured to execute the instructions to:
acquire request information being transmitted from a user terminal and including a use start point of a vehicle, a use end point of the vehicle, and a time point when the vehicle is to be used;
generate a travel plan for each of a plurality of vehicles including vehicles assigned to each piece of the request information in such a way that, when a degree of similarity of a plurality of pieces of the request information satisfies a predetermined criterion, the plurality of vehicles travel in a connected state in a partial travel section; and
output the travel plan.

2. The information processing apparatus according to claim 1, wherein the vehicle is a vehicle being remotely operated by an operator.

3. The information processing apparatus according to claim 1, wherein the processor is further configured to execute the instructions to assign a single operator for collectively operating the plurality of vehicles to the partial travel section where the plurality of vehicles travel in a connected state.

4. The information processing apparatus according to claim 1, wherein the degree of similarity is a degree of similarity between pieces of the request information regarding a travel route of the vehicle and a travel time range of the vehicle for achieving transportation requested in the request information.

5. The information processing apparatus according to claim 4, wherein the processor is further configured to execute the instructions to correct the travel route or the travel time range in a case where the vehicle travels without being connected to another vehicle, within a predetermined allowable range, and calculate the degree of similarity between pieces of the request information by using the corrected travel route or travel time range.

6. The information processing apparatus according to claim 5, wherein the predetermined allowable range for a travel section where the vehicle travels in a state where an object to be transported is not on the vehicle is larger than the predetermined allowable range for a travel section where the vehicle travels in a state where the object to be transported is on the vehicle.

7. The information processing apparatus according to claim 1, wherein the processor is further configured to execute the instructions to output, to an apparatus being used by an operator of the vehicle, information related to a vehicle being a connection partner of the vehicle.

8. An information processing method comprising, by an information processing apparatus:
acquiring request information being transmitted from a user terminal and including a use start point of a vehicle, a use end point of the vehicle, and a time point when the vehicle is to be used;
generating a travel plan for each of a plurality of vehicles including vehicles assigned to each piece of the request information in such a way that, when a degree of similarity of a plurality of pieces of the request information satisfies a predetermined criterion, the plurality of vehicles travel in a connected state in a partial travel section; and
outputting the travel plan.

9. The information processing method according to claim 8, wherein the vehicle is a vehicle being remotely operated by an operator.

10. The information processing method according to claim 8, further comprising assigning a single operator for collectively operating the plurality of vehicles to the partial travel section where the plurality of vehicles travel in a connected state.

11. The information processing method according to claim 8, wherein the degree of similarity is a degree of similarity between pieces of the request information regarding a travel route of the vehicle and a travel time range of the vehicle for achieving transportation requested in the request information.

12. The information processing method according to claim 11, wherein the generating the travel plan further includes correcting the travel route or the travel time range in a case where the vehicle travels without being connected to another vehicle, within a predetermined allowable range, and calculating the degree of similarity between pieces of the request information by using the corrected travel route or travel time range.

13. The information processing method according to claim 12, wherein the predetermined allowable range for a travel section where the vehicle travels in a state where an object to be transported is not on the vehicle is larger than the predetermined allowable range for a travel section where the vehicle travels in a state where the object to be transported is on the vehicle.

14. The information processing method according to claim 8, further comprising outputting, to an apparatus being used by an operator of the vehicle, information related to a vehicle being a connection partner of the vehicle.

15. A non-transitory computer readable medium storing a program that causes a computer to execute:
a request acquiring step of acquiring request information being transmitted from a user terminal and including a use start point of a vehicle, a use end point of the vehicle, and a time point when the vehicle is to be used;
a connected-travel plan generating step of generating a travel plan for each of a plurality of vehicles including vehicles assigned to each piece of the request information in such a way that, when a degree of similarity of a plurality of pieces of the request information satisfies a predetermined criterion, the plurality of vehicles travel in a connected state in a partial travel section; and
an output step of outputting the travel plan.

16. The non-transitory computer readable medium according to claim 15, wherein the vehicle is a vehicle being remotely operated by an operator.

17. The non-transitory computer readable medium according to claim 15, wherein the program further causes the computer to execute an operator assignment step of assigning a single operator for collectively operating the plurality of vehicles to the partial travel section where the plurality of vehicles travel in a connected state.

18. The non-transitory computer readable medium according to claim 15, wherein the degree of similarity is a degree of similarity between pieces of the request information regarding a travel route of the vehicle and a travel time range of the vehicle for achieving transportation requested in the request information.

19. The non-transitory computer readable medium according to claim 18, wherein the connected-travel plan generating step further includes correcting the travel route or the travel time range in a case where the vehicle travels without being connected to another vehicle, within a predetermined allowable range, and calculating the degree of similarity between pieces of the request information by using the corrected travel route or travel time range.

20. The non-transitory computer readable medium according to claim 19, wherein the predetermined allowable range for a travel section where the vehicle travels in a state where an object to be transported is not on the vehicle is larger than the predetermined allowable range for a travel section where the vehicle travels in a state where the object to be transported is on the vehicle.
